(19) United States
(12) Patent Application Publication
(10) Pub. No.: US 2026/0267785 A1
(43) Pub. Date: Sep. 10, 2026

(54) SYSTEM RESOURCE INVOCATION METHOD AND ELECTRONIC DEVICE

(71) Applicant: CLOUD INTELLIGENCE ASSETS HOLDING (SINGAPORE) PRIVATE LIMITED, Singapore (SG)

(72) Inventor: Yinde ZHANG, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/167,883

(22) PCT Filed: Feb. 28, 2024
(86) PCT No.: PCT/CN2024/079108

§ 371 Date: Sep. 23, 2025

(30) Foreign Application Priority Data
Mar. 24, 2023 (CN) 202310313277.9

(51) Int. Cl. G06F 11/3698

(52) U.S. Cl. CPC G06F 11/3698

(57) ABSTRACT

A system resource invocation method and electronic device are provided. The method includes: in response to a resource invocation request initiated by a first application for a target system resource, determining a first application sandbox corresponding to the first application, wherein different applications respectively correspond to different application sandboxes, address information of a system resource upon which a corresponding application relies is recorded in a resource information set included in each application sandbox, the target system resource has a plurality of versions, and different versions of the target system resource are respectively relied upon by different applications; and according to a resource name of the target system resource, querying a first resource information set included in the first application sandbox to obtain target address information corresponding to the resource name, and invoking resources according to the target address information.

### CROSS REFERENCE TO RELATED APPLICATIONS

This application is a National Stage of International Stage of International Application PCT/CN2024/079108 filed on Feb. 28, 2024, which claims priority to Chinese Patent Application No. 202310313277.9 entitled “METHOD AND APPARATUS FOR CALLING SYSTEM RESOURCES” filed on Mar. 24, 2023, the entire contents of the mentioned applications are incorporated herein by reference in their entireties.

### TECHNICAL FIELD

One or more embodiments of this specification relate to the field of computers, and in particular, to a system resource invocation method and apparatus.

### BACKGROUND

An operating system of a computer such as a local physical machine or a Virtual Machine (VM) may control running of an application (that is, an application program, or referred to as an APP). During running, the application usually needs to depend on system resources such as a Software Development Kit (SDK) provided by the operating system. A plurality of applications may concurrently run on the same computer, and these applications may respectively depend on different versions of the same system resource, that is, respectively depend on system resources with the same name but different versions.

In a related technology, for a system resource of a particular version on which any application depends, when searching for the system resource according to a resource name of the system resource, a computer may find the system resource of another version on which another application depends, and invoke the system resource. Consequently, the application may run abnormally or even fail to start.

### SUMMARY

In view of this, one or more embodiments of this specification provide system resource invocation.

To achieve the above objective, one or more embodiments of this specification provide the following technical solution.

According to a first aspect of one or more embodiments of this specification, a system resource invocation method is provided, including: determining, in response to a resource invocation request initiated by a first application for a target system resource, a first application sandbox corresponding to the first application, where different applications respectively correspond to different application sandboxes, a resource information collection included in each of the application sandboxes records address information of system resources on which an application corresponding to the application sandbox depends, the target system resource has a plurality of versions, and different versions of the target system resource are respectively depended on by different applications; and querying, according to a resource name of the target system resource, target address information corresponding to the resource name in a first resource information collection included in the first application sandbox, and performing resource invocation according to the target address information.

According to a second aspect of one or more embodiments of this specification, a system resource invocation apparatus is provided, including: a sandbox determination unit, configured to determine, in response to a resource invocation request initiated by a first application for a target system resource, a first application sandbox corresponding to the first application, where different applications respectively correspond to different application sandboxes, a resource information collection included in each of the application sandboxes records address information of system resources on which an application corresponding to the application sandbox depends, the target system resource has a plurality of versions, and different versions of the target system resource are respectively depended on by different applications; and a resource invocation unit, configured to query, according to a resource name of the target system resource, target address information corresponding to the resource name in a first resource information collection included in the first application sandbox, and perform resource invocation according to the target address information.

According to a third aspect of one or more embodiments of this specification, an electronic device is provided, including: a processor; and a memory configured to store instructions executable by the processor; the processor implements the method according to the first aspect by running the executable instructions.

According to a fourth aspect of one or more embodiments of this application, a computer-readable storage medium is provided, having computer instructions stored therein, where the instructions implement steps of the method according to any item in the first aspect when executed by a processor.

### BRIEF DESCRIPTION OF DRAWINGS

In accompanying drawings, unless otherwise specified, the same reference signs throughout the plurality of accompanying drawings represent the same or similar parts or elements. These accompanying drawings may not necessarily be drawn to scale. It is to be understood that these accompanying drawings only describe some implementations disclosed in this application, and are not to be construed as limiting the scope of this application.

FIG. 1 is a schematic diagram of an architecture of a cloud desktop system according to an exemplary embodiment.

FIG. 2 is a schematic diagram of a system resource invocation method according to an exemplary embodiment.

FIG. 3 is a schematic diagram of an internal structure of a computer according to an exemplary embodiment.

FIG. 4 is a schematic structural diagram of a device according to an exemplary embodiment.

FIG. 5 is a block diagram of a system resource invocation apparatus according to an exemplary embodiment.

### DETAILED DESCRIPTION

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments are not all the implementations consistent with one or more embodiments of this specification. On the contrary, the implementations only examples of apparatuses and methods that are described in the appended claims in detail and that are consistent with some aspects of one or more embodiments of this specification.

It is to be noted that: steps of a corresponding method are not necessarily performed according to a sequence shown and described in this specification in other embodiments. In some other embodiments, the methods may include more or fewer steps than those described in this specification. In addition, a single step described in this specification may be decomposed into a plurality of steps for describing in other embodiments. A plurality of steps described in this specification may be combined into a single step for describing in other embodiments.

As described above, a plurality of applications may concurrently run on the same computer, and these applications may respectively depend on different versions of the same system resource provided by a system, that is, respectively depend on system resources with the same name but different versions. In a running process of an application, if a system resource needs to be invoked, an invocation request for the resource may be initiated to an operating system, so that the operating system performs resource invocation in response to the request. Related information of the resource required for running of the application may constitute a resource information collection of the application, so that the operating system searches for the resource required for the running of the application in the resource information collection according to resource information of the resource.

In a related technology, if a plurality of applications concurrently run on a computer, resource information collections respectively corresponding to the applications are sequentially loaded to an operating system according to a fixed query sequence. The loaded resource information collections form a unidirectional data structure (such as a linked list) corresponding to the query sequence, so that the operating system can query any system resource requested by any application in each resource information collection only according to the query sequence.

Because the loaded resource information collections usually record resources in a form of resource names and address information, for a system resource that is of a certain resource name and a certain version and that is requested to be obtained by any application, the operating system usually performs invocation by using a first resource whose name matches the resource name as a query result when querying according to the foregoing query sequence based on the resource name. However, an actual version of the resource may not be the certain version that is requested to be invoked by the application, but is another version on which another application depends. That is, the query result is wrong, and then the application may run abnormally or even fails to start.

To resolve the foregoing problem existing in the related technology, this specification provides a system resource invocation method. An application sandbox is set for each application, and a system resource on which each application depends is isolated in advance, so that when searching for a system resource on which any application depends, an operating system only needs to search in resources recorded in an application sandbox corresponding to the application, thereby avoiding a case in which a found version is incorrect. The method will be described in detail below with reference to accompanying drawings.

The system resource invocation method in this embodiment of this specification may be applied to a computer, and specifically, applied to an operating system of the computer. The computer may be a local computer or a virtual machine. A specific function that can be implemented by an application running on the computer is not limited in the present disclosure. For example, a first application may be an office application, a shopping application, a payment application, an instant messaging application, a music application, or the like. Details are not described again.

For example, when the computer is the local computer, a plurality of applications running locally on the computer may be managed by an operating system of the local computer. A user of the local computer may perform an interactive operation with the computer by using an input device connected to the computer, to implement interaction with applications running in the local computer, so that these applications may provide corresponding preset functions for the user by using the output device.

For another example, when the computer is the virtual machine, a plurality of applications running on the virtual machine may be managed by an operating system of the virtual machine. A user of the virtual machine may perform an interactive operation with the computer by using an input device connected to a hardware device on which the virtual machine is located, or an input device connected to a network device to which the virtual machine is connected, to implement interaction with applications running on the virtual machine, so that these applications may provide corresponding preset functions for the user by using corresponding output devices.

Using the virtual machine as an example, any virtual machine may independently run in a terminal device, or may run together with other virtual machines in a server. For example, a plurality of virtual machines may concurrently run in any server, each virtual machine is separately controlled by an operating system of the server, and software and hardware resources of the server may be properly allocated to each virtual machine for use. One or more applications may be deployed and run in the foregoing computer, and the operating system of the computer may run in a user mode or a kernel mode at any time.

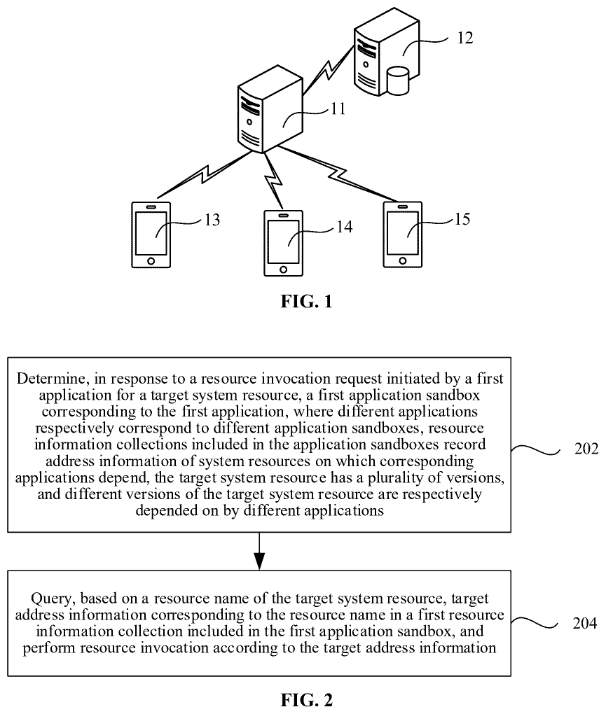

FIG. 1 is a schematic diagram of an architecture of a cloud desktop system according to an exemplary embodiment. The system may include a server 11, a storage device 12, and several electronic devices such as a mobile phone 13, a mobile phone 14, and a mobile phone 15. At least one virtual machine (not shown in the figure) may be deployed in the application server 11. Any virtual machine may run an application locally to implement the virtual machine as an application server, and provide a corresponding application service for an application client.

A cloud desktop is alternatively referred to as desktop virtualization, a cloud computer, and the like, and a computing mode of the cloud desktop may that replace a conventional local computer. A user does not need to purchase a computer host, and components such as a Central Processing Unit (CPU), a memory, and a hard disk required for running of the host may be implemented and provided by a resource of a cloud desktop server by using a virtualization technology. The user may use any form of terminal device as a cloud desktop client, and the cloud desktop client is connected to the cloud desktop server through a network. The cloud desktop client and the cloud desktop server cooperate to form a complete computer in a cloud desktop scenario. In a case that a cloud desktop instance is deployed in any virtual machine, based on an application running in the instance, the virtual machine may provide a cloud desktop service for electronic devices such as mobile phones 13 to 15. In this scenario, the virtual machine is implemented as a cloud desktop server, and the mobile phone used by the user is equivalent to the cloud desktop client. It may be understood that the electronic device as an application client may include hardware such as a control module, a communication module, a display, a keyboard, and a mouse, so that the user can exchange information with the application server by using the foregoing hardware.

For any application running in any virtual machine, data (a program, code, or the like) required for running of the application or data (intermediate data, a data processing result, a running record, or the like) generated in a running process may be stored locally in the virtual machine, or may alternatively be stored in the storage device 12. The virtual machine may locally mount data stored in the storage device 12 as a Virtual Hard Disk (VHD) by using a VHD technology, so as to perform remote read and write operations on the data of the VHD during running of the application. Therefore, the application does not need to be locally installed on the virtual machine, thereby simplifying application maintenance operations on the virtual machine and saving local storage space of the virtual machine.

In addition, any one of the mobile phones 13 to 15 may run a client program, so that the mobile phone is implemented as the cloud desktop client in the cloud desktop system. The cloud desktop client may essentially be an application program, and the application program may be pre-installed on a mobile phone, so that the client can be started and run on the terminal device. Certainly, when an online “client” such as a HyperText Markup Language 5 (HTML5) technology is used, the client can be obtained and run without installing a corresponding application program on the mobile phone. Correspondingly, the cloud desktop instance running in the server 11 may be considered as a server-side program, and any virtual machine may implement the virtual machine as a server in the cloud desktop system by running the program.

Any one of the foregoing mobile phones may correspond to a corresponding user. For example, any user may use a user account of the user to log in to a client running in the mobile phone 13, and after logging in, the user may be considered as a user corresponding to the mobile phone 13. The mobile phone 13 may interact with the server 11 during logging in, so that the user can log in to any virtual machine in the server 11. In addition, the mobile phones 13 to 15 are only one type of electronic devices that can be used by the user. The user may further use, for example, the following types of electronic devices: tablet devices, notebook computers, Personal Digital Assistants (PDAs), wearable devices (such as smart glasses and smart watches), Virtual Reality (VR) devices, Augmented Reality (AR) devices, and the like. By running a client program of a cloud desktop on these devices, these devices may be implemented as cloud desktop clients. Certainly, to implement any one of the foregoing electronic devices as the cloud desktop client, the client program may need to be installed in the device or a client program in an online form may be accessed. Actually, a user may further use a cloud desktop dedicated device. For example, the cloud desktop client may be pre-installed in the device. The user only needs to connect a corresponding input/output device to the device to access an application running in a corresponding cloud desktop server by using the cloud desktop client and by implementing corresponding operations, to obtain a cloud desktop service provided by the device.

In addition, the server 11 may be a physical server including an independent host, or may be a virtual server, a cloud server, or the like carried by a host cluster. The storage device 12 may be in any form, for example, may be a structured or non-structured database, or may be a Network Attached Storage (NAS) device. This is not limited in one or more embodiments of this specification.

FIG. 2 is a flowchart of a system resource invocation method according to an exemplary embodiment. As shown in FIG. 2, the method is applied to an operating system of a computer, and includes the following steps 202 to 204.

Step 202: Determine, in response to a resource invocation request initiated by a first application for a target system resource, a first application sandbox corresponding to the first application, where different applications respectively correspond to different application sandboxes, a resource information collection included in each of the application sandboxes records address information of system resources on which an application corresponding to the application sandbox depends, the target system resource has a plurality of versions, and different versions of the target system resource are respectively depended on by different applications.

The operating system of the computer described in this solution may be Windows, or may be iOS, Linux, Unix, or the like. Windows is used as an example for description below. The first application may be any application running in the foregoing computer. A running process of the application program needs to depend on a system resource provided by the operating system, for example, a hardware resource such as a memory and a CPU, and/or a software resource such as a Software Development Kit (SDK) and file management.

In addition, an application sandbox corresponding to any application described in this specification is a program, a rule, or an environment configured for performing permission isolation/management on related data or a resource of the application, and may be configured for recording resources on which the application depends (that is, resources that are required in a running process of the application). For example, resource names of these resources and address information of the resources in the computer may be recorded, so that the operating system may query address information of any resource according to a resource name of the resource and perform resource invocation according to the found address information.

In an embodiment, the first application sandbox corresponding to the first application may be pre-created, for example, a corresponding first application sandbox is created for the first application during installing of the application. Thereafter, the application may start and run in the application sandbox, data generated during running is correspondingly stored in the application sandbox. Running isolation and data isolation between the first application and other applications are fully implemented, and mutual interference between applications is avoided.

In another embodiment, the first application sandbox corresponding to the first application may alternatively be temporarily created by the operating system during startup of the first application. For example, the operating system may create the first application sandbox for the first application in response to a startup instruction for the application. Then, an executable file of the first application is executed in memory space corresponding to the first application sandbox, to start the application. The startup instruction may be initiated by a user of the first application. After receiving the startup instruction, the operating system may create the first application sandbox in the memory space of the computer, to increase a data processing speed related to the first application. The executable file is a main program configured for starting the first application, that is, the first application may be started in the memory space of the computer after the file is executed. A format of the executable file is not limited in this embodiment of this specification. For example, the executable file may be an .exe file, an .sys file, a .com file, a .dll file, or the like. Details are not described again. After the startup is completed, when needing to invoke the target system resource, the first application may initiate the resource invocation request for the resource to the operating system, to trigger the operating system to invoke the resource for the first application in response to the request.

The executable file of the first application belongs to a source file of the first application (the file is configured to record basic data such as a main program and code required for running the application). The source file may be pre-stored in a NAS device. In this case, the operating system may locally mount the executable file in a form of a VHD by using a VHD technology, and further add the VHD to the first application sandbox, so as to subsequently read the file in a remote access manner. In a case that the first application sandbox has been created, the operating system may record address information of the source file in the first application sandbox, and then read the executable file in a manner of remotely accessing the source file. Or, address information of the executable file may be first determined from the source file, and then the address information is recorded in the first application sandbox, so that the executable file is obtained based on the address information of the NAS in a remote access manner.

Address information of any resource described in this specification is configured for indicating an access address of the resource, and the resource may be accessed (that is, invoked) according to the address information. The address information may be an index corresponding to a data storage address, or may be an invocation interface, a parameter, or the like of a software and hardware resource. A specific form of the address information is not limited in this specification. For example, for the SDK provided by the operating system, the address information of the SDK may be a path specified by the operating system for the SDK (the SDK may be invoked through the path). Certainly, the address information of the resource may alternatively include a second-level address that can be redirected, or other indication information that can be configured for accessing the resource. Details are not described one by one again.

Certainly, because the source file of the first application may be generated based on a preset index, to ensure that the mounted source file can run normally, the operating system may perform redirection processing on the source file. If the source file is generated based on a “C:\Program Files” folder, in a case that the source file is mounted to any folder under any drive letter of the computer, the operating system may redirect address information of the folder to “C:\Program Files”, to ensure that all files in the source file can be normally accessed and run according to an index after the redirection.

In this manner, the operating system is allowed to locally mount the source file of the first application by using the VHD technology, and then add the source file to the first application sandbox. It may be understood that the source file may be generated by a publisher or a manager of the application in a pre-execution manner. In this case, the operating system can start and run the first application only by remotely accessing the source file, and does not need to “install” the first application locally on the computer, so that the first application can achieve a running effect of a cloud application, and deployment and maintenance workload of a user on the first application is greatly simplified. In addition, it helps save local storage space of the computer, so that the computer can run more applications concurrently, thereby improving an overall resource utilization rate of the computer.

In still another embodiment, a corresponding first application sandbox may alternatively be created for the application in a running process after the first application is started. For example, invocation for a resource, an operation on data, and the like may be involved in the running process of the first application, and the operating system may check all requests sent by the application, to identify a sensitive request therein. In a case that data that requests to be processed is sensitive data or a resource that requests to be invoked is a sensitive resource, the request may be determined as a sensitive request. The sensitive data may be a resource occupied or possibly occupied by another application, and the sensitive resource may be a resource invoked or possibly invoked by another application. In this case, the first application sandbox may be directly created for the first application, or a prompt instruction may be returned to the first application, so that the first application presents prompt information for the sensitive data and/or sensitive resource to a current user, and the user determines whether to create the first application sandbox for the first application. After the first application sandbox is created, related data generated during startup of the first application may be transferred to the sandbox, and then processing on the sensitive data or invocation of the sensitive resource is completed in the sandbox in response to the sensitive request. In this manner, a corresponding first application sandbox may be created for the first application when necessary, and is not created when not needed. Although a response time of a first sensitive request is prolonged, more resources can be saved for the computer by using a more strict application sandbox creation threshold (because creation and maintenance of the application sandbox similarly need to consume resources for calculation, storage, and the like). Especially in a case that a running process of the first application does not relate to sensitive data or a sensitive resource, a resource saving effect is more prominent.

Continuing to the foregoing embodiment, the system resource invocation method may be applied to a virtual machine on which a cloud desktop instance is deployed. In this case, the first application may run in the cloud desktop instance, and the first application may be published to a cloud application platform. It may be understood that the first application sandbox similarly belongs to the cloud desktop instance. In this scenario, the virtual machine is equivalent to a cloud desktop server, and terminal devices (which may include a control module, a communication module, a display, a keyboard, a mouse, and the like) used by a user form a cloud desktop client. In this scenario, the virtual machine may provide an application browsing page of the cloud application platform for the cloud desktop client. The page may include display of the first application, for example, a startup control, introduction content, detailed information, an operation guide, or a user rating of the first application. In view of this, the user may perform a trigger operation for the foregoing display of the first application, and the cloud desktop client may initiate the startup instruction for the first application in response to the trigger operation, to trigger the virtual machine to start the first application. In this manner, the first application may be provided for the user in a form of a cloud application without actually installing the first application in the virtual machine, which not only helps simplify deployment and maintenance work of the user on the first application, but also helps save local storage space of the computer, and improves overall resource utilization rate of the computer.

In addition, because a plurality of applications may concurrently run on the computer, and each application may be created with a corresponding application sandbox, the operating system may further create (or set or allocate) a corresponding application sandbox identifier for each application sandbox, and maintain a first-class mapping relationship between an application identifier of each application and an application sandbox identifier of a corresponding application sandbox. Or, in a case that applications respectively run in different processes, a second-class mapping relationship between a Process Identifier (PID) of a process where each application is located and an application sandbox identifier of a corresponding application sandbox may be maintained, to facilitate subsequent determination of the first application sandbox.

Regardless of whether the first application sandbox is pre-created during installing of the first application, or is temporarily created during startup of the first application, a first resource information collection of the first application needs to be recorded in the created first application sandbox. The collection includes address information of system resources on which the first application depends. Before the system resource is started (for example, before the executable file is executed), the operating system may obtain, from the source file of the first application, a resource name and a version of each system resource on which the first application depends, then query corresponding address information in resource storage space (for example, local storage space of the computer) of the operating system according to the resource name and the version, and then associatively record the resource name and the corresponding address information in the first resource information collection. In the foregoing manner, it can be ensured that the system resource represented by each piece of address information recorded in the first resource information collection is a system resource on which the first application depends. If any system resource has a plurality of versions (that is, there are a plurality of system resources with the same name but different versions) and any two of the versions are respectively depended on by different applications, corresponding address information is recorded in an application sandbox respectively corresponding to each application, that is, address information of any system resource of any version is recorded in an application sandbox of an application which depends on the version of the system resource.

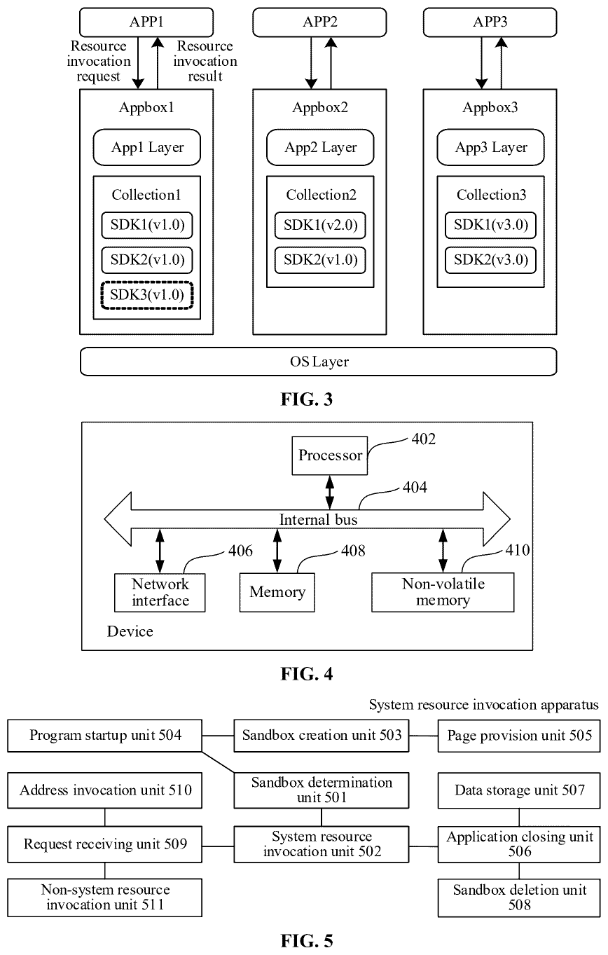

The first application started in the foregoing manner may start to run normally in a computer (for example, the foregoing virtual machine). As shown in FIG. 3, three applications, namely, an APP1, an APP2, and an APP3, run on a computer. Each application has a corresponding application sandbox, for example, the APP1 corresponds to an Appbox1, the APP2 corresponds to an Appbox2, and the APP3 corresponds to an Appbox3. Each application sandbox includes a source file (an App Layer1, an App Layer2, and an App Layer3) and a resource information collection (a Collection1, a Collection2, and a Collection3) of a corresponding application. The source file may be mounted to an operating system and added to an application sandbox by using a VHD technology. The system resources on which the corresponding applications depend are recorded in the resource information collections. For example, the Collection1 records an SDK1 (v1.0) (a resource name is “SDK1”, and a version is 1.0, which are the same below), an SDK 2(v 1.0 ), and an SDK 3(v 1.0 ) on which the APP1 depends. The Collection2 records an SDK1 (v2.0) and an SDK2 (v1.0) on which the APP2 depends. The Collection3 records an SDK1 (v3.0) and an SDK2 (v3.0) on which the APP3 depends. It is to be noted that, although a corresponding version is marked for each SDK in FIG. 3, version information of the SDK is not needed in a resource query process, to reduce a data volume of the resource information collection as much as possible and save available storage space of the application sandbox, the resource information may not record the version, but only record a resource name and address information of the resource.

Any one of the foregoing SDKs may be a system resource, or may be a non-system resource. For example, for each SDK on which the APP1 depends, the SDK1 (v1.0) and the SDK2 (v1.0) may be system resources, and the SDK3 (v1.0) may be a non-system resource. For a certain version of a system resource which any application depends on, another version of the system resource may be depended on by another application. For example, for the SDK1, the APP1 depends on a version 1.0 of the SDK1, the APP2 depends on a version 2.0 of the SDK1, and the APP3 depends on a version 3.0 of the SDK1. Certainly, the system resource of any version on which any application depends may be depended on by another application. For example, for the SDK2, both the APP1 and the APP2 depend on a version 1.0 of the SDK2. However, it is to be noted that, for the SDK2, in this case, neither the APP1 nor the APP2 can be used as the foregoing first application. Moreover, a non-system resource on which any APP depends is usually provided by a publisher or an administrator of the application (not provided by an operating system of a computer) and is exclusively occupied by the APP. Therefore, this type of resource is depended on only by the APP. For example, the SDK3 has only a version 1.0 and is only depended on by the APP1. Actually, the non-system resource may not be included in the application sandbox, to reduce permission management load of the application sandbox as much as possible. System resources that are not respectively occupied by a plurality of applications may not be recorded in a corresponding application sandbox.

In addition, although an Operating System (OS) Layer in FIG. 3 is separately drawn, the OS Layer only represents that each application can share all system resources provided by the computer (for example, evenly share a memory resource, occupy a CPU resource according to a load status, and invoke an SDK of a version required by each application according to a record of the resource information collection), and it cannot be understood that system resources exist independently of an application sandbox. Actually, for system resources of corresponding versions on which three APPs respectively depend: for the SDK1 and the SDK2, the SDK1 and the SDK2 may both belong to a part of the OS Layer.

In a running process of the first application, if a target system resource (which may be any resource on which the application depends) needs to be invoked, a resource invocation request for the resource may be initiated to an operating system. In response to the request, the operating system may first determine the first application sandbox corresponding to the first application.

As described above, the operating system may maintain a first-class mapping relationship between an application identifier of an application and a sandbox identifier of an application sandbox, and may alternatively maintain a second-class mapping relationship between a process identifier of a process where an application is located and a sandbox identifier of an application sandbox. In an embodiment, the operating system may determine the first application sandbox in different manners according to different maintained mapping relationships. For example, in a case that the first-class mapping relationship is maintained, the sandbox identifier corresponding to the application identifier of the first application may be determined according to the mapping relationship, and an application sandbox represented by the sandbox identifier is determined as the first application sandbox. For another example, in a case that the second-class mapping relationship is maintained, a sandbox identifier corresponding to a first process identifier of a process where the first application is located may be determined according to the mapping relationship, and an application sandbox represented by the sandbox identifier is determined as the first application sandbox. In this case, different applications respectively run in different processes, so that interference that may be generated in running processes of the different applications can be reduced as much as possible, and running stability of each application can be improved. The application identifier of the first application or the first process identifier of the process where the first application is located may be determined by the first application and included in the initiated resource invocation request, to improve a response speed of the operating system.

Step 204: Query, according to a resource name of the target system resource, target address information corresponding to the resource name in a first resource information collection included in the first application sandbox, and perform resource invocation according to the target address information.

As described above, the first resource information collection records a resource name and address information of each system resource on which the first application depends. Therefore, after determining the resource name of the target system resource, the operating system may query target address information corresponding to the resource name in the first resource information collection included in the first application sandbox, and then perform resource invocation according to the information. It may be understood that, resource invocation is performed according to the target address information, that is, a corresponding target system resource is invoked according to the information, that is, the target system resource which the target access address represented by the target address information points to is invoked.

In this solution, the operating system of the computer creates a corresponding application sandbox for each application running on the computer, and the resource information collection included in the application sandbox corresponding to any application records the address information of the system resource on which the application depends, so that system resources of corresponding versions required for running of the application are all isolated in the application sandbox. Based on this, in response to the resource invocation request initiated by the first application for the target system resource (required for running of the first application), the operating system may first determine the first application sandbox corresponding to the first application, and then query corresponding target address information in the first resource information collection included in the sandbox according to the resource name of the target system resource, where the address is an invocation address of the target system resource required by the first application, so that resource invocation can be performed on the target system resource according to the address.

It may be understood that the resource information collection included in the application sandbox corresponding to any application is configured for recording address information of each system resource of a specific version that is required in a running process of the application (that is, on which the application depends). Therefore, the system resource represented by each piece of address information recorded in the first resource information collection is a system resource of a specific version on which the first application depends. Therefore, what is found in the collection according to the resource name of the target system resource is necessarily the target system resource of the specific version required by the first application, rather than a system resource of another version. Because the first application is any application of the plurality of applications concurrently running on the computer, in this solution, a system resource of a corresponding version on which any application depends can be accurately searched and invoked, thereby ensuring smooth running of the application.

As shown in FIG. 3, it is assumed that the first application is an APP1, and the target system resource is an SDK1 (v1.0). In this case, the operating system may determine, according to the resource name “SDK1” included in the resource invocation request, the SDK1 as the target system resource (or a process identifier of a process where the target system resource is located)-but does not know and does not need to know which version of the SDK1 is specifically requested by the APP1. Then, the target address information corresponding to the resource name may be queried in the Collection1 according to the resource name, where the SDK which the address points to is an SDK of a corresponding version that is requested to be obtained by the APP1. In addition, there may be a fixed query sequence (that is, a query sequence described in the related technology) between the foregoing three resource information collections. In this case, modifications of this solution based on the related technology are relatively small, which facilitates efficient promotion and efficient application of this solution. Certainly, the foregoing query sequence may not exist.

In an embodiment, the target system resource may be invoked from the target address information in a plurality of manners. For example, to-be-processed data specified by the resource invocation request may be first obtained, and then the to-be-processed data is processed by using the target system resource read from the target address information. The to-be-processed data may be local data of the computer, may be data stored in the storage device, or may be intermediate data or a running result provided by another application, or the like. Details are not described again. In this manner, an APP may invoke the target system resource to process the to-be-processed data specified by the APP. Certainly, after the processing is completed, a processing result may further be provided to a corresponding demand side, for example, returned to the APP1, so as to be presented to a user, or submitted to the storage device to update the to-be-updated data that has been stored, or submitted, across an application sandbox, to another application that provides the to-be-processed data, as an invocation result of the another application for the first application. Details are not described again.

So far, a process in which the first application invokes the target system resource is completely described. As described above, in a case that the first application depends on a non-system resource in addition to the system resource, the first resource information collection included in the first application sandbox may further record a resource name and address information of the non-system resource. Therefore, the first application may further invoke these resources during running. For example, the operating system may receive the resource invocation request that is sent by the first application for any non-system resource. Then, the address information of the non-system resource may be queried in the first resource information collection, and resource invocation is performed according to the address information, that is, the any non-system resource to which the access address represented by the address information points is invoked. A specific process of querying and invoking the non-system resource is similar to the foregoing corresponding process of the system resource. Details are not described again.

Or, the first resource information collection may alternatively directly record each non-system resource (that is, the resource). In this case, after receiving the resource invocation request that is sent by the first application for any non-system resource, the operating system may directly query the non-system resource in the first resource information collection and invoke the found non-system resource. For example, when any non-system resource is an SDK, and the first resource information collection records executable code of the SDK, the SDK may be directly searched for according to the resource identifier information (for example, a resource identifier, a resource name, and/or a version) carried in the resource invocation request, and the found executable code of the SDK is copied to memory space corresponding to the first application sandbox for execution. Details are not described again. In the foregoing manner, the first application may smoothly invoke any non-system resource, to ensure normal running of the first application.

In an embodiment, after the first application completes running, the operating system may close the first application in response to a closing instruction for the first application. The closing instruction may be actively initiated by a first user, and in this case, the first application may be closed according to a volition of the user; or, the closing instruction may be automatically initiated by the operating system according to a preset plan, and in this case, the application may be closed according to the foregoing preset plan. For a specific closing process, refer to descriptions in the related technology. Details are not described herein again.

In addition to closing the first application, a current running result generated during running of the first application may further be stored in the foregoing NAS device, to be reused in a subsequent running process of the first application. For example, in the first application startup process, a local running result may be read from the NAS device, so that the user can view a previous running result after the first application is restarted, the user can carry out work in sequence, and troubles brought to the user by data loss is avoided. And/or, the first application sandbox may be deleted after the first application is closed, to recycle resources occupied by the first application, thereby improving a utilization rate of the resources.

FIG. 4 is a schematic structural diagram of a device according to an exemplary embodiment. Referring to FIG. 4, from a perspective of hardware, the device includes a processor 402, an internal bus 404, a network interface 406, a memory 408, and a non-volatile memory 410. Certainly, the device may further include hardware required by other functions. One or more embodiments of this specification may be implemented based on software. For example, the processor 402 reads a corresponding computer program from a non-volatile memory 410 and runs the computer program in the memory 408. Certainly, in addition to a software implementation, one or more embodiments of this specification do not exclude other implementations, for example, logic devices or a software-hardware combination. That is, execution bodies of the following processing procedures are not limited to logic units and may alternatively be hardware or logic devices.

Referring to FIG. 5, in a software implementation, a system resource invocation apparatus may include: a sandbox determination unit 501, configured to determine, in response to a resource invocation request initiated by a first application for a target system resource, a first application sandbox corresponding to the first application, where different applications respectively correspond to different application sandboxes, a resource information collection included in each of the application sandboxes records address information of system resources on which an application corresponding to the application sandbox depends, the target system resource has a plurality of versions, and different versions of the target system resource are respectively depended on by different applications; and a system resource invocation unit 502, configured to query, according to a resource name of the target system resource, target address information corresponding to the resource name in a first resource information collection included in the first application sandbox, and perform resource invocation according to the target address information.

In an embodiment, the sandbox determination unit 501 is configured to: determine, according to a maintained first-class mapping relationship between an application identifier of an application and a sandbox identifier of an application sandbox, a sandbox identifier corresponding to an application identifier of the first application, and determine the application sandbox represented by the sandbox identifier as the first application sandbox; or in a case that different applications respectively run in different processes, determine, according to a maintained second-class mapping relationship between a process identifier of a process where an application is located and a sandbox identifier of an application sandbox, a sandbox identifier corresponding to a first process identifier of a process where the first application is located, and determine the application sandbox represented by the sandbox identifier as the first application sandbox.

In an embodiment, the system resource invocation unit 502 is configured to: obtain to-be-processed data specified by the resource invocation request; and process the to-be-processed data by using the target system resource read from the target address information.

In some implementations, the apparatus further includes: a sandbox creation unit 503, configured to create the first application sandbox for the first application in response to a startup instruction for the first application; and a program startup unit 504, configured to execute an executable file of the first application in memory space corresponding to the first application sandbox, to start the first application, where the resource invocation request is initiated by the first application after startup is completed.

In some implementations, the method is applied to a virtual machine on which a cloud desktop instance is deployed, the first application runs in the cloud desktop instance, the first application is published to a cloud application platform, and the apparatus further includes: a page provision unit 505, configured to provide an application browsing page of the cloud application platform for a cloud desktop client, where the application browsing page includes display of the first application, and the startup instruction is initiated by the cloud desktop client in response to a trigger operation performed on the display of the first application.

In some embodiments, the apparatus further includes: an application closing unit 506, configured to close the first application in response to a closing instruction for the first application; a data storage unit 507, configured to store a running result generated during running of the first application to a NAS device for reuse in a subsequent running process of the first application; and/or, a sandbox deletion unit 508, configured to delete the first application sandbox after the first application is closed.

In some embodiments, the first application further depends on a non-system resource, and the apparatus further includes: a request receiving unit 509, configured to receive the resource invocation request that is sent by the first application for any non-system resource; an address invocation unit 510, configured to query address information of the non-system resource in the first resource information collection, and perform resource invocation according to the address information; or, a non-system resource invocation unit 511, configured to query the non-system resource in the first resource information collection, and invoke the found non-system resource.

In this solution, the operating system of the computer creates a corresponding application sandbox for each application running on the computer, and the resource information collection included in the application sandbox corresponding to any application records the address information of the system resource on which the application depends, so that system resources of corresponding versions required for running of the application are all isolated in the application sandbox. Based on this, in response to the resource invocation request initiated by the first application for the target system resource (required for running of the first application), the operating system may first determine the first application sandbox corresponding to the first application, and then query corresponding target address information in the first resource information collection included in the sandbox according to the resource name of the target system resource, where the address is an invocation address of the target system resource required by the first application, so that resource invocation can be performed on the target system resource according to the address.

It may be understood that the resource information collection included in the application sandbox corresponding to any application is configured for recording address information of each system resource of a specific version that is required in a running process of the application (that is, on which the application depends). Therefore, the system resource represented by each piece of address information recorded in the first resource information collection is a system resource of a specific version on which the first application depends. Therefore, what is found in the collection according to the resource name of the target system resource is necessarily the target system resource of the specific version required by the first application, rather than a system resource of another version. Because the first application is any application of the plurality of applications concurrently running on the computer, in this solution, a system resource of a corresponding version on which any application depends can be accurately searched and invoked, thereby ensuring smooth running of the application.

The system, the apparatus, the module or the unit described in the foregoing embodiments may be specifically implemented by a computer chip or an entity, or implemented by a product having a function. A typical implementation device is a computer. A specific form of the computer may be a personal computer, a laptop computer, a cellular phone, a camera phone, a smartphone, a personal digital assistant, a media player, a navigation device, an email transceiver device, a game console, a tablet computer, a wearable device or a combination of any devices of these devices.

In a typical configuration, the computer includes one or more processors (such as CPUs), an input/output interface, a network interface, and a memory.

The memory may include a form such as a volatile memory, a Random-Access Memory (RAM) and/or a non-volatile memory such as a Read-Only Memory (ROM) or a flash RAM in a computer-readable medium. The memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of a storage medium of a computer include, but are not limited to, a Phase-Change Memory (PRAM), a Static Random-Access Memory (SRAM), a Dynamic Random-Access Memory (DRAM), a RAM of another type, a Random Only Memory (ROM), an Electrically Erasable Programmable Read-Only Memory (EEPROM), a Flash Memory or another memory technology, a Compact Disk Read-Only Memory (CD-ROM), a Digital Versatile Disk (DVD) or another optical storage device, a cassette tape, a magnetic disk storage, a quantum memory, a graphene-based storage medium or another magnetic storage device, or any other non-transmission medium, which may be configured to store information accessible by a computing device. According to definitions herein, the computer-readable medium does not include transitory computer-readable media, such as a modulated data signal and carrier.

It is further to be noted that, terms “include”, “contain” or any other variations thereof are intended to cover a non-exclusive inclusion, such that a process, method, commodity, or device including a series of elements not only includes those elements, but also includes those elements that are not explicitly listed, or includes elements inherent to such a process, method, commodity or device. Unless otherwise specified, an element limited by “include a/an . . . ” does not exclude other same elements existing in the process, the method, the article, or the device that includes the element.

Embodiments of this specification are described above. Other embodiments fall within the scope of the appended claims. In some cases, actions or steps recorded in the claims may be performed in sequences different from those in the embodiments and may still achieve an expected result. In addition, processes depicted in accompanying drawings are not necessarily performed in a specific sequence or successively to achieve an expected result. In some implementations, multitasking and parallel processing may be feasible or beneficial.

Terms used in one or more embodiments of this specification are merely used to describe specific embodiments but are not intended to limit one or more embodiments of this specification. “A”, “the”, and “this” in a singular form used in one or more embodiments of this specification and the appended claims are alternatively intended to include a plural form, unless other meanings are clearly indicated in context. It is further to be understood that term “and/or” used herein indicates and includes any or all possible combinations of one or more associated listed items.

It is to be understood that although terms “first”, “second”, “third” and the like may be used to describe various types of information in one or more embodiments of this specification, such information is not limited to these terms. These terms are merely used to distinguish between information of the same type. For example, without departing from the scope of one or more embodiments of this specification, first information may alternatively be referred to as second information. Similarly, second information may alternatively be referred to as first information. Depending on the context, for example, the word “if” used herein may be interpreted as “while” or “when” or “determining . . . in response to”.

The foregoing descriptions are merely preferred embodiments of one or more embodiments of this specification, but are not intended to limit the one or more embodiments of this specification. Any modification, equivalent replacement, or improvement made within the spirit and principle of one or more embodiments of this specification fall within the protection scope of the one or more embodiments of this specification.

1. A system resource invocation method, comprising:
determining, in response to a resource invocation request initiated by a first application for a target system resource, a first application sandbox corresponding to the first application, wherein different applications respectively correspond to different application sandboxes, a resource information collection comprised in each of the application sandboxes records address information of system resources on which an application corresponding to the application sandbox depends, the target system resource has a plurality of versions, and different versions of the target system resource are respectively depended on by different applications; and
querying, according to a resource name of the target system resource, target address information corresponding to the resource name in a first resource information collection comprised in the first application sandbox, and performing resource invocation according to the target address information.

2. The method according to claim 1, wherein the determining the first application sandbox corresponding to the first application comprises:
determining, according to a maintained first-class mapping relationship between an application identifier of an application and a sandbox identifier of an application sandbox, a sandbox identifier corresponding to an application identifier of the first application, and determining the application sandbox represented by the sandbox identifier as the first application sandbox; or,
in a case that different applications respectively run in different processes, determining, according to a maintained second-class mapping relationship between a process identifier of a process where an application is located and a sandbox identifier of an application sandbox, a sandbox identifier corresponding to a first process identifier of a process where the first application is located, and determining the application sandbox represented by the sandbox identifier as the first application sandbox.

3. The method according to claim 1, wherein the performing resource invocation according to the target address information comprises:
obtaining to-be-processed data specified by the resource invocation request; and
processing the to-be-processed data by using the target system resource read based on the target address information.

4. The method according to claim 1, further comprising:
creating the first application sandbox for the first application in response to a startup instruction for the first application; and
executing an executable file of the first application in a memory space corresponding to the first application sandbox, to start the first application, wherein the resource invocation request is initiated by the first application after startup is completed.

5. The method according to claim 4, wherein the method is applied to a virtual machine on which a cloud desktop instance is deployed, the first application runs in the cloud desktop instance, the first application is published to a cloud application platform, and the method further comprises:
providing an application browsing page of the cloud application platform for a cloud desktop client, wherein the application browsing page comprises display of the first application, and
the startup instruction is initiated by the cloud desktop client in response to a trigger operation performed on the display of the first application.

6. The method according to claim 1, further comprising:
closing the first application in response to a closing instruction for the first application;
storing a running result generated during running of the first application to a network attached storage device for reuse in a subsequent running process of the first application; and/or, deleting the first application sandbox after the first application is closed.

7. The method according to claim 1, wherein the first application further depends on a non-system resource, and the method further comprises:
receiving a resource invocation request that is sent by the first application for any non-system resource; and
querying address information of the non-system resource in the first resource information collection, and performing resource invocation according to the address information; or,
querying the non-system resource in the first resource information collection, and invoking the found non-system resource.

8. (canceled)

9. An electronic device, comprising:
a processor; and
a memory configured to store instructions executable by the processor, wherein
the processor runs the executable instructions to perform operations comprising:
determining, in response to a resource invocation request initiated by a first application for a target system resource, a first application sandbox corresponding to the first application, wherein different applications respectively correspond to different application sandboxes, a resource information collection comprised in each of the application sandboxes records address information of system resources on which an application corresponding to the application sandbox depends, the target system resource has a plurality of versions, and different versions of the target system resource are respectively depended on by different applications; and
querying, according to a resource name of the target system resource, target address information corresponding to the resource name in a first resource information collection comprised in the first application sandbox, and performing resource invocation according to the target address information.

10. A non-transitory computer-readable storage medium, having computer instructions stored therein, wherein the instructions implement steps of the method according to claim 1 when executed by a processor.

11. The electronic device according to claim 9, wherein the determining the first application sandbox corresponding to the first application comprises:
determining, according to a maintained first-class mapping relationship between an application identifier of an application and a sandbox identifier of an application sandbox, a sandbox identifier corresponding to an application identifier of the first application, and determining the application sandbox represented by the sandbox identifier as the first application sandbox; or,
in a case that different applications respectively run in different processes, determining, according to a maintained second-class mapping relationship between a process identifier of a process where an application is located and a sandbox identifier of an application sandbox, a sandbox identifier corresponding to a first process identifier of a process where the first application is located, and determining the application sandbox represented by the sandbox identifier as the first application sandbox.

12. The electronic device according to claim 9, wherein the performing resource invocation according to the target address information comprises:
obtaining to-be-processed data specified by the resource invocation request; and
processing the to-be-processed data by using the target system resource read based on the target address information.

13. The electronic device according to claim 9, wherein the operations further comprise:
creating the first application sandbox for the first application in response to a startup instruction for the first application; and
executing an executable file of the first application in a memory space corresponding to the first application sandbox, to start the first application, wherein the resource invocation request is initiated by the first application after startup is completed.

14. The electronic device according to claim 13, wherein a virtual machine is deployed on the electronic device, a cloud desktop instance is deployed on the virtual machine, the first application runs in the cloud desktop instance, the first application is published to a cloud application platform, and the operations further comprise:
providing an application browsing page of the cloud application platform for a cloud desktop client, wherein the application browsing page comprises display of the first application, and
the startup instruction is initiated by the cloud desktop client in response to a trigger operation performed on the display of the first application.

15. The electronic device according to claim 9, wherein the operations further comprise:
closing the first application in response to a closing instruction for the first application;
storing a running result generated during running of the first application to a network attached storage device for reuse in a subsequent running process of the first application; and/or, deleting the first application sandbox after the first application is closed.

16. The electronic device according to claim 9, wherein the first application further depends on a non-system resource, and the operations further comprise:
receiving a resource invocation request that is sent by the first application for any non-system resource; and
querying address information of the non-system resource in the first resource information collection, and performing resource invocation according to the address information; or,
querying the non-system resource in the first resource information collection, and invoking the found non-system resource.
